(19) United States
(12) Patent Application Publication
(10) Pub. No.: US 2012/0111198 A1
(43) Pub. Date: May 10, 2012

(54) Straight pore microfilter with efficient regeneration

(76) Inventors: Han Liu, Timonium, MD (US); Anthony B. LaConti, Lynnfield, MA (US); Thomas J. McCallum, Ashland, MA (US); Edwin W. Schmitt, Arlington, MA (US)

(21) Appl. No.: 13/068,904

(22) Filed: May 23, 2011

Related U.S. Application Data
(60) Provisional application No. 61/396,061, filed on May 21, 2010.

(51) Int. Cl. B01D 46/00; B05D 5/00

(52) U.S. Cl. 95/285; 55/492; 55/486; 55/487; 427/244

(57) ABSTRACT

A gas particulate filter well-suited for, but not limited to, removing airborne particulates from air. According to one embodiment, the filter is a composite structure including a porous support and an ionomer coating. The porous support is preferably made of a material designed to endow the filter with good mechanical properties. The pores of the porous support are preferably micron or smaller straight pores. The ionomer coating, which is applied to the porous support but does not completely seal the pores of the porous support, is preferably selected to provide the filter with good filtering properties and regeneration through controlled ionomer hydration/dehydration and corresponding ionomer swelling and contraction.

### CROSS-REFERENCE TO RELATED APPLICATIONS

The present application claims the benefit under 35 U.S.C. 119(e) of U.S. Provisional Patent Application No. 61/396,061, filed May 21, 2010, the disclosure of which is incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. NNX09CD14P awarded by NASA Glenn Research Ctr.

### BACKGROUND OF THE INVENTION

The present invention relates generally to filters well-suited for use in removing airborne particulates from air and relates more particularly to a novel such filter.

The three major types of techniques used to remove airborne particulates from air are (1) inertial separation, (2) electrostatic precipitation, and (3) mechanical filtration. A brief review of each of these techniques is presented below.

Inertial separation is also commonly referred to as cyclone collection or centrifugal separation (see Springer et al., “Air Pollution Control Equipment and Strategies,” Industrial Environmental Control Pulp and Paper Industry, (3^{rd} ed.), A. M. Springer (Ed.), pp. 537-62, Atlanta, Ga.; TAPPI Press (2000), which is incorporated herein by reference). In inertial separation, particulate-laden air is forced into a cylindrical chamber to create a fast spiral motion. The particulates are then separated from the air by centrifugal force and inertia.

The major disadvantages of inertial separation are low separation efficiency and high energy consumption. In addition, the size of particles that can be successfully separated by inertial separation is also limited. More specifically, inertial separation can effectively remove large particles, i.e., particles greater than 30 μm in diameter, but exhibits low separation efficiency for finer particulates, i.e., particles 5-10 μm in diameter. Certain manufacturers of inertial separation equipment claim, for a gas that is particulate-laden, an efficiency of greater than 99% for particles that are greater than 10 μm in diameter and an efficiency of 90% for particles that are greater than 5 μm in diameter (see Cooper et al., Air Pollution Control: A Design Approach (3^{rd} ed.), Long Grove, Ill., Waveland Press, Inc. (2002), which is incorporated herein by reference). Higher efficiency usually requires higher gas velocity, which directly translates to higher pressure drop and energy consumption, which is not desirable. Thus, inertial separation is better suited for use as a preliminary treatment technique for dust-laden air to eliminate large particles before transporting the air to a more rigorous filtration/separation technique.

Electrostatic precipitation is a technique commonly used to remove dry particulates, or even liquid droplets, from flue gases. In many instances, electrostatic precipitation can achieve a removal efficiency of greater than 99% and even as high as up to 99.8% for new systems (see Asbach et al., “Investigation on gas particle separation efficiency of the gas particle partitioner,” Atmosph. Environ., 39:7825-35 (2005), which is incorporated herein by reference). In electrostatic precipitation, dust-laden air is passed through a chamber with discharge and collection electrodes. A high voltage is applied to the discharge electrodes, which creates a very strong electric field that ionizes the gas within the chamber. The ionized gas molecules, which hold negative charges, migrate towards the positively-charged collection electrode plates. As they migrate, the gas ions bombard particulates in the air of the chamber and transfer their charge to the particulates, which are then attracted to the collection plates.

The major disadvantages of electrostatic precipitation are particle size limitation and ozone generation. With respect to particle size limitation, electrostatic precipitation, in contrast with inertial separation, cannot efficiently remove larger particles, especially when the air flow rate is high. With respect to ozone generation, since the air molecules must be ionized using high voltages, ozone and NOₓ are inevitably generated, both of which are considered hazardous to human health. Additionally, the byproduct generation rate increases with voltage/current, and higher voltage/current is generally preferred due to higher separation efficiency. The polarity of the electrostatic precipitation equipment also plays an important role in ozone generation. It is found that, although negative-polarity electrostatic precipitators (ESPs) have better energy efficiency, positive-polarity ESPs can reduce the amount of ozone generation five times (see Huang et al., “Filtration characteristics of a miniature electrostatic precipitator, Aero. Sci. Tech., 35:792-804 (2001), which is incorporated herein by reference). The health issues presented by the generation of ozone/NOₓ are especially problematic for aerospace applications since, in these applications, the air is re-circulated. As a result, the amount of ozone/NOₓ accumulates over time, which can lead to an unsafe concentration level. Finally, it should be noted that ESPs can actually generate ultra-fine particles (4.6-157 nm) under certain conditions (see Waring et al., “Ultrafine particle removal and generation by portable air cleaners, Atmosph. Environ., 42:5003-14 (2008), which is incorporated herein by reference).

Mechanical filtration involves passing dust-laden air through a porous fabric, usually made of non-woven fibers, whereby the particulates become trapped in the porous fabric and, therefore, are removed from the air passed through the filter. High separation efficiency, i.e., greater than 99%, can often be achieved. Periodically, the filter may be cleaned by mechanical force, such as by shaking, by reverse air flow or by high pressure pulses to restore pressure drop.

Although conventional fabric filters can be designed to have excellent removal efficiency (e.g., high efficiency particulate air (HEPA) filters can have a rated efficiency of 99.97% for particles greater than or equal to 0.3 μm), the energy consumption is usually very high (see Fisk et al., “Performance and Costs of Particle Air Filtration Technologies,” Indoor Air, 12:223-4 (2002), which is incorporated herein by reference). For example, a home unit with a flow of 140 liters/sec (L/s) may consume 350 W of electricity.

To improve the efficiency of mechanical filtration for smaller particles, nanofibrous filtering media have been developed (see Barhate et al., “Nanofibrous Filtering Media: Filtration Problems and Solutions from Tiny Materials, J. Mem. Sci., 296:1-8 (2007), which is incorporated herein by reference). The nanofibers of these filters have significantly smaller diameters than the conventional glass/nylon microfibers used in HEPA filters. As expected, filtration efficiency improves for smaller particles when nanofibers are employed in the filter. Correspondingly, pressure drop also increases, which results in an increase in energy consumption.

An approach to lower the pressure drop is to adopt electret fibers in the filters. Electret is a dielectric material that produces a permanent electric field without an externally applied voltage. The disadvantage of electret filters is that the attraction force provided thereby decreases as the fibers become covered with particles (see Jaworek et al., “Modern Electrostatic Devices and Methods for Exhaust Gas Cleaning, A Brief Review,” J. Electrostat., 65:133-55 (2007), which is incorporated herein by reference).

There are four predominant mechanisms for particle separation in fiber-based filters: interception, inertial impaction, diffusion, and electrostatics. Based on the complicated filtration mechanisms of fiber-based filters, high efficiency filters not only require thinner fibers and dense packing but also require greater thickness (see Wang et al., “Prediction of Air Filter Efficiency and Pressure Drop in Air Filtration Media Using a Stochastic Simulation,” Fibers and Poly., 9:34-8 (2008), which is incorporated herein by reference). All of these factors inevitably increase pressure drop and energy consumption during filtration. Additionally, since the separated particulates are deposited deeply inside the filter body, cleaning and regeneration of a dirty or fouled filter can be challenging.

Ultrasonication has been successfully adopted to reduce membrane fouling. Various parameters have been examined to enhance cleaning efficiency: frequency, power intensity, membrane properties, temperature, pressure, etc. (see Kyllönen et al., “Membrane Filtration Enhanced by Ultrasound: A Review,” Desalination, 181:319-35 (2005), which is incorporated herein by reference). Although ultrasonication shows promise in liquid filtration systems, it can be a challenge to apply ultrasonication to air systems. The key phenomenon for effective ultrasonication cleaning is cavitation, which is absent in air filtration systems. Liquids can also facilitate the propagation of ultrasonic sound waves significantly better than air can. Air bubbles have been found to be detrimental to cleaning efficiency (see Chen et al., “Ultrasonic Control of Ceramic Membrane Fouling by Particles: Effect of Ultrasonic Factors,” Ultrason: Sonochem., 13:379-87 (2006), which is incorporated herein by reference). Additionally, sonication can introduce membrane fractures and defects due to mechanical stress for both polymer-based membranes and ceramic membranes (see Masselin et al., J. Mem. Sci., 181:213-20 (2001), which is incorporated herein by reference, and Chen et al., Ultrasonic Control of Ceramic Membrane Fouling by Particles: Effect of Ultrasonic Factors,” Ultrason. Sonochem., 13:379-87 (2006)).

Cleaning agents have also been used to facilitate filter regeneration (see Hidal et al., “Methods Employed for Control of Fouling in MF and UF Membranes: A Comprehensive Review,” Separa. Sci. Tech., 40:1957-2005 (2005), which is incorporated herein by reference). For undersea and aerospace applications especially, employment of cleaning agents may not be a desirable choice as the cleaning agents are additional consumable materials. The cleaning agents usually need water as the carrier, which is an important commodity in undersea and aerospace applications. For the cleaning agents to be highly effective, it should cover the surface of the captured particulates, which leads to high consumption. The cleaning agents will be most effective when the filter is back-flushed with large amounts of water or a water/air mixture. Dry air will dry up the cleaning agents and may worsen the fouling condition. Thus, cleaning agents can be a good choice for terrestrial filter filtration and not a good choice for undersea and aerospace applications, especially when automated regeneration is desired.

In addition to inertial separation, electrostatic precipitation, and mechanical filtration, a fourth type of industrial particulate removal technique is venturi scrubbing. Venturi scrubbers usually require a rinse liquid, such as water, to capture solid contaminates that are present in air. Post-treatment of the rinsing water can create further filtration challenges. Thus, the technique is not suitable for many applications.

### SUMMARY OF THE INVENTION

It is an object of the present invention to provide a novel filter.

It is another object of the present invention to provide a filter that addresses at least some of the shortcomings associated with the above-described filters.

According to one aspect of the invention, there is provided a filter well-suited for removing particulates from a gas, the filter comprising (a) a support, the support comprising a plurality of straight pores extending from one surface of the support to an opposite surface of the support; and (b) an ionomer coating applied to the support, the ionomer coating partially filling but not completely sealing at least some of the straight pores. According to one embodiment, the support is made of a non-ionomer polymer film selected from the group consisting of polyimide, a liquid crystal polymer, and polybenzimidazole. The support may have a thickness of about 9 to 25 microns, preferably about 9 to 15 microns. The straight pores may have a pore size of about 10 to 80 μm, preferably about 10 to 30 and the support may have a porosity of about 40 to 60%, preferably about 40 to 50%. The ionomer coating may comprise a perfluorinated sulfonic acid or a suflonated hydrocarbon and may have an equivalent weight of about 700 to 1100. Preferably, the filter has a dust removal efficiency of about 90 to 99%, more preferably about 95 to 99%.

The present invention is also directed at a filter assembly, the filter assembly comprising a plurality of stacked filters, at least one of said stacked filters comprising a filter as described above. According to one embodiment, the filter assembly may comprises a first filter and a second filter, the second filter being stacked on the first filter, the first filter comprising a non-woven porous fabric, the second filter comprising a filter as described above. According to another embodiment, the filter assembly comprises a plurality of stacked filters, each of the stacked filters comprising a filter as described above.

The present invention is further directed at a method of filtering particulates from a gas, the method comprising the steps of (a) providing a filter, the filter comprising (i) a support, the support comprising a plurality of straight pores extending from one surface of the support to an opposite surface of the support; and (ii) an ionomer coating applied to the support, the ionomer coating partially filling but not completely sealing at least some of the straight pores, and (b) passing the gas through the pores of the filter.

The present invention is further directed at a method of preparing a gas particulate filter, said method comprising the steps of (a) forming a support having a plurality of straight pores; and (b) applying an ionomer to the support so as to partially fill, but not completely seal, at least some of the straight pores. According to one embodiment, the support forming step comprises providing a support and using a laser, such as an excimer laser, to micromachine straight pores in the support. According to another embodiment, micromolding is used to form the support having a plurality of straight pores.

Additional objects, as well as aspects, features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. In the drawings wherein like reference numerals represent like parts:

FIG. 1 is a section view of one embodiment of a filter constructed according to the teachings of the present invention;

FIG. 2 is a fragmentary top perspective view of the support shown in FIG. 1;

FIG. 3 is a schematic depiction of the laser micromachining technique of near-field imaging;

FIG. 4 is a schematic depiction of the swelling/shrinking of an ionomer-coated filter;

FIG. 5 is a graphic representation of the surface area increase of an ionomer-coated filter for different total dry diameters and volume swelling ratios;

FIG. 6 is an SEM micrograph of a support obtained according to the technique of Example 1;

FIG. 7 is a schematic depiction of the micromolding process discussed in Example 2;

FIG. 8 is a schematic depiction of the coating wheel discussed in Example 2;

FIG. 9 is an SEM micrograph of a PSU support fabricated using a PDMS micromold as discussed in Example 2;

FIGS. 10(a) and 10(b) are SEM micrographs of supports sprayed with an ionomer solution after 4 passes and after 8 passes, respectively, as discussed in Example 3;

FIGS. 11(a) and 11(b) are SEM micrographs of a filter, viewed from above and in cross-section, respectively, obtained after spraying with 48 passes, as discussed in Example 3;

FIG. 12 is an SEM micrograph of a filter sprayed with an ionomer solution after 64 passes, as discussed in Example 3;

FIG. 13 is an SEM micrograph of a filter sprayed with an ionomer solution after 220 passes, as discussed in Example 3;

FIG. 14 is a schematic depiction of a final filtration test system design, as discussed in Example 4;

FIG. 15 is a graphic representation of the particle density of a clean system, as discussed in Example 4;

FIG. 16 is a graphic representation of the particle density of a clean system and during a low-rate dispensing test, as discussed in Example 4;

FIG. 17 is a graphic representation of the comparative pressure drops of a filter of the present invention (“GES Filter”) and of a HEPA filter, as discussed in Example 4;

FIG. 18 is a graphic representation of the pressure drop and efficiency of a filter of the present invention (“GES filter”) prepared using a KAPTON® polyimide support, as discussed in Example 5;

FIG. 19 is a graphic representation of the efficiency of a filter of the present invention (“GES filter”) prepared using a KAPTON® polyimide support as a function of particle size and time, as discussed in Example 5;

FIG. 20 is a photograph of a filter of the present invention at the end of the filtration test performed in Example 5;

FIG. 21 is a graphic representation of the effect of regeneration on pressure drop for a number of different filters tested in Example 5;

FIG. 22 is a graphic representation of the pressure drop profile during filter regeneration with water performed in Example 5;

FIG. 23 is an SEM micrograph of a filter contaminated with 10 μm microspheres, as discussed in Example 5;

FIG. 24 is a graphic representation of the reproducibility of filter generation discussed in Example 5;

FIG. 25 is a graphic representation of the pressure drop and efficiency of a filter of the present invention with a lunar dust simulant, as discussed in Example 5;

FIG. 26 is a graphic representation of the efficiency of a filter of the present invention as a function of particle size and time for a lunar dust simulant, as discussed in Example 5;

FIG. 27 is a graphic representation of a comparison between recovery efficiency of lunar dust-contaminated and microsphere-contaminated filters, as discussed in Example 5;

FIG. 28 is an SEM micrograph of a surface of the ceramic filter discussed in Example 5;

FIG. 29 is an SEM micrograph of a cross-section of the ceramic filter discussed in Example 5; and

FIG. 30 is a graphic representation of a comparison of the pressure drop for different clean filter media, as discussed in Example 5.

### DETAILED DESCRIPTION OF THE INVENTION

The present invention is directed at a novel filter that is well-suited for use in, but is not limited to, removing airborne particulates from air. The filter of the present invention is preferably a composite structure comprising a porous support and an ionomer coating. The porous support is preferably made of a material designed to endow the filter with good mechanical properties. The pores of the porous support are preferably micron or smaller straight pores. The ionomer coating, which is applied to the porous support but does not completely seal the pores of the porous support, is preferably selected to provide the filter with good filtering properties and regeneration through controlled ionomer hydration/dehydration and corresponding ionomer swelling and contraction.

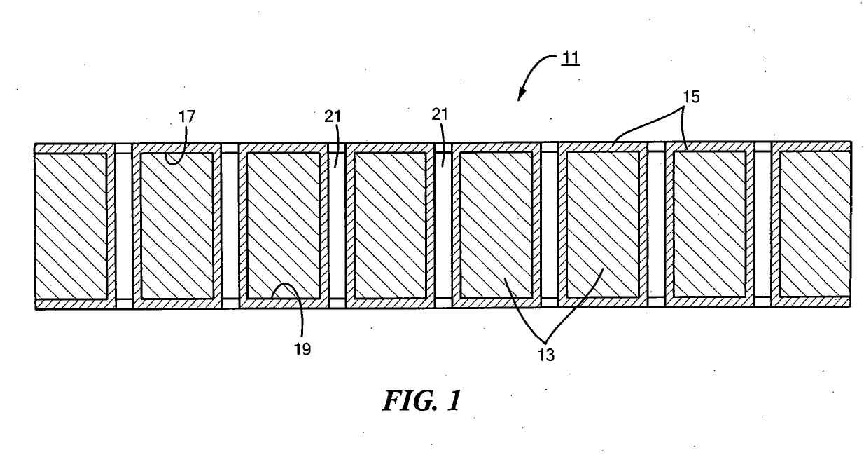

Referring now to FIG. 1, there is shown a section view of one embodiment of a filter constructed according to the teachings of the present invention, the filter being represented generally by reference numeral 11.

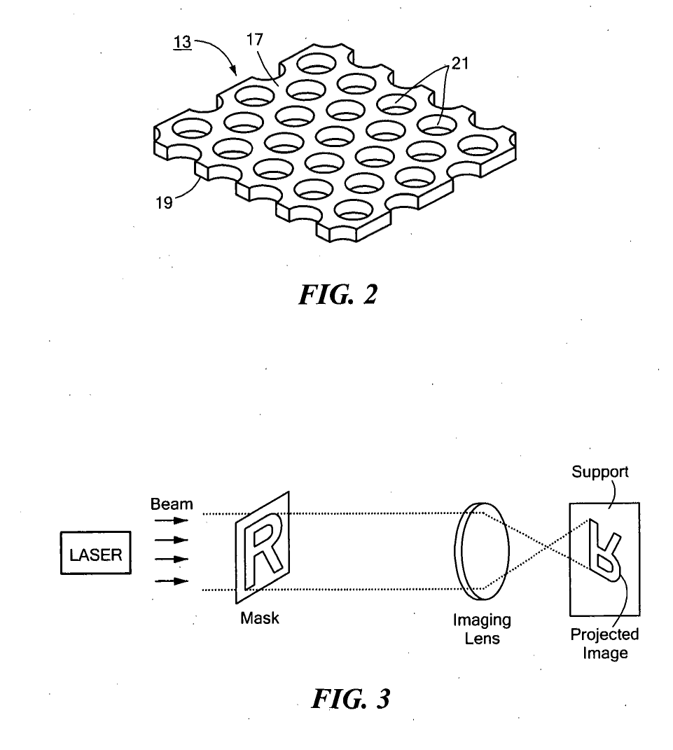

Filter 11 comprises a porous support 13 and an ionomer coating 15. Support 13, which is shown separately in FIG. 2, is a generally sheet-like, unitary structure, preferably of high mechanical strength, having a top surface 17 and a bottom surface 19. The thickness of support 13 may vary, depending on the particular use to which filter 11 is put. For most applications, support 13 has a thickness of about 9 to 25 μm, preferably about 9 to 15 μm.

Support 13 is preferably a generally rigid member and is preferably chemically resistant to acid and water hydrolysis at elevated temperatures. Examples of materials that may be suitable for use in making support 13 include, but are not limited to, perfluorinated polymers, polyvinylidene fluoride, poly(tetrafluoroethylene), polybenzimidazole, polyphenylenesulfide, polysulfone, polyethersulfone, polyesters, polyparaphenylene, polyquinoxaline, polyarylketone, polybenzazole, polyaramid, poly(etherether-ketone), liquid crystal polymers, polyimide, and polyetherimide.

KAPTON® polyimide (DuPont, Wilmington, Del.), which has a high strength, good hydrolysis stability and excellent thermal properties, is a particularly desirable material for use in making support 13. Ultra-thin membranes of KAPTON® polyimide (8.5 μm and 17 μm) are commercially available and may be used to make support 13. VECTRA® liquid crystal polymers (Goodfellow, Cambridgeshire, UK) also have superb mechanical, chemical and thermal stability and may be used to make support 13.

Although the polymers discussed above as being suitable for use in making support 13 are non-ionic, ionomers may alternatively be used. Examples of cationic ionomers that may be suitable include carboxylated, sulfonated, or phosphorylated derivatives of the polymers discussed above. Examples of anionic ionomers that may be suitable include amino, imino, ammonium, sulfonium, and phosphonium derivatives of the polymers discussed above.

A plurality of pores 21, preferably cylindrical in shape, extend in a direct, i.e., straight-line, fashion from top surface 17 to bottom surface 19 of support 13. It should be noted that the cross-sectional shape of the pore may be circular, as in the present embodiment, or may be chosen from a variety of other two-dimensional geometric shapes. Pores 21 preferably each have a diameter of about 10 to 80 μm, more preferably about 10 to 30 μm, and pores 21 preferably constitute about 40 to 60%, more preferably about 40 to 50%, of support 13. Pores 21 may be arranged in a uniform hexangular pattern over the entirety of support 13. It is to be understood, however, that the present invention is not limited to the above-described pattern of pores and may encompass other patterns of evenly distributing the pores or unevenly distributing the pores, such an uneven distribution of pores including, for example, a lesser concentration of pores along the periphery of support 13 and a greater concentration of pores 21 elsewhere.

Pores 21 may be provided in support 13 by a variety of different techniques. One such technique that may be used involves lasing support 13 with suitable laser light. There are two major categories of lasers: gas lasers and solid state lasers. Although either gas lasers or solid state lasers may be used to create pores 21, gas lasers are preferred. Within the class of gas lasers, there are two major types of lasers: CO₂ lasers and excimer lasers, with excimer lasers being preferred over CO₂ lasers. This is because excimer lasers produce laser light having a much shorter wavelength than that produced by CO₂ lasers (about 0.3 μm for an excimer laser vs. about 10 μm for a CO₂ laser). Consequently, because of their shorter wavelengths, excimer lasers directly excite the covalent bonds of the support and decompose the support without creating as extreme high-temperature conditions as is the case with CO₂ lasers. Additionally, due to their shorter wavelengths, excimer lasers can create significantly smaller pores than can CO₂ lasers.

In those cases in which a CO₂ laser is used to micromachine pores into support 13, the whole laser beam is focused onto an area of the support until the irradiated area is ablated, this process being known as focal point micromachining. In those cases in which an excimer laser is used, the relatively uniform beam intensity produced thereby provides an alternative approach to pore formation: near-field imaging. In near-field imaging, which is schematically depicted in FIG. 3, a mask having a pattern is placed in the path of the beam emitted by the excimer laser. The light transmitted through the pattern of the mask is then focused by an imaging lens onto the support, resulting in the mask pattern being projected onto the support, with a corresponding pattern of pores being formed in the support. As can readily be appreciated, near-field imaging enables various alternative patterns to be projected onto the support simply by using differently patterned masks.

An alternative technique that may be used to form pores 21 in support 13 is micromolding. Micromolding is based on the technique of soft lithography (see Kumar et al., Appl. Phys. Lett., 63:2002 (1993) and Michel et al., IBM J. Res. & Dev., 45:697-719 (2001), both of which are incorporated herein by reference). Ultra-fine patterns in nanometer scale have been successfully demonstrated using this technique (see Whitesides et al., Annu. Rev. Biomed. Eng., 3:335-73 (2001), which is incorporated herein by reference). This technique has the potential to be very inexpensive with high production throughput.

The soft lithography process starts with a master mold. The master mold, with predefined patterns of photoresist, can be created by photolithography technology that is widely used in the microelectronics industry. Alternatively, the base master material can be patterned by plasma deep etch technology (see Ayón et al., Smart Mater. Struct., 10:1135-44 (2001), which is incorporated herein by reference). Since the master material, e.g., silicon, usually has significantly higher mechanical strength than polymer based photoresist material, the lifetime of the master mold potentially can be enhanced drastically.

Once the master mold is created, a liquid precursor of polydimethylsiloxane (PDMS) is coated on the surface of the master. After a curing/solidification process, the formed PDMS soft mold/stamp can be easily peeled off the master mold. The PDMS mold has a negative pattern of the master mold.

To create a patterned polymer support structure, the solution/precursor of the polymer support is coated on the soft mold. Similar to soft mold formation, the support structure can be simply peeled off the soft mold once solidified. Since the PDMS has very low surface tension, the adhesion between the polymer support and the soft mold is usually not a major concern. Since one master mold can generate many inexpensive soft molds, which in turn can produce many products, the potential cost of the process is low.

Ionomer coating 15 may be applied to support 13 by preparing a solution of a suitable ionomer and then spraying the ionomer solution onto support 13 or by dipping support 13 into the ionomer solution. Ionomers suitable for use in the present invention include, but are not limited to, perfluorinated sulfonic acid (PFSA) and sulfonated hydrocarbon materials, such as sulfonated polystyrene, sulfonated polysulfone, and sulfonated polyphenylene oxide, with PFSA being a preferred ionomer. The ionomer solution may be sprayed onto support 13 in a series of layers to build up to a final thickness.

Ionomer coating 15 does not completely seal pores 21 of support 13, but rather, is coated onto support 13 so as to maintain the pore structure open. Several parameters, such as ionomer concentration, spraying solution delivery rate, and spray head speed, may be varied to create samples with a controlled amount of ionomer coating or shell on support 13. By controlling the hole pattern in the support structure and the ionomer shell thickness, a series of filters with different ionomer shell thicknesses and hole diameters may be readily prepared.

Compared to conventional filtration materials, such as polycarbonate, nylon and glass fibers, one of the distinguishing features of ionomers is that the volume of an ionomer can drastically change under different conditions of relative humidity (RH) and/or temperature. In particular, the volume change can be extremely high when the ionomer is in contact with liquid water at an elevated temperature. With 700EW perfluorinated ionomers (equivalent weight (EW) being the weight of ionomer (in grams) containing 1 mole of ionic groups, lower EW meaning the ionomer contains more ionic groups per gram), the volume can increase by a factor of approximately two when in contact with 100° C. liquid water.

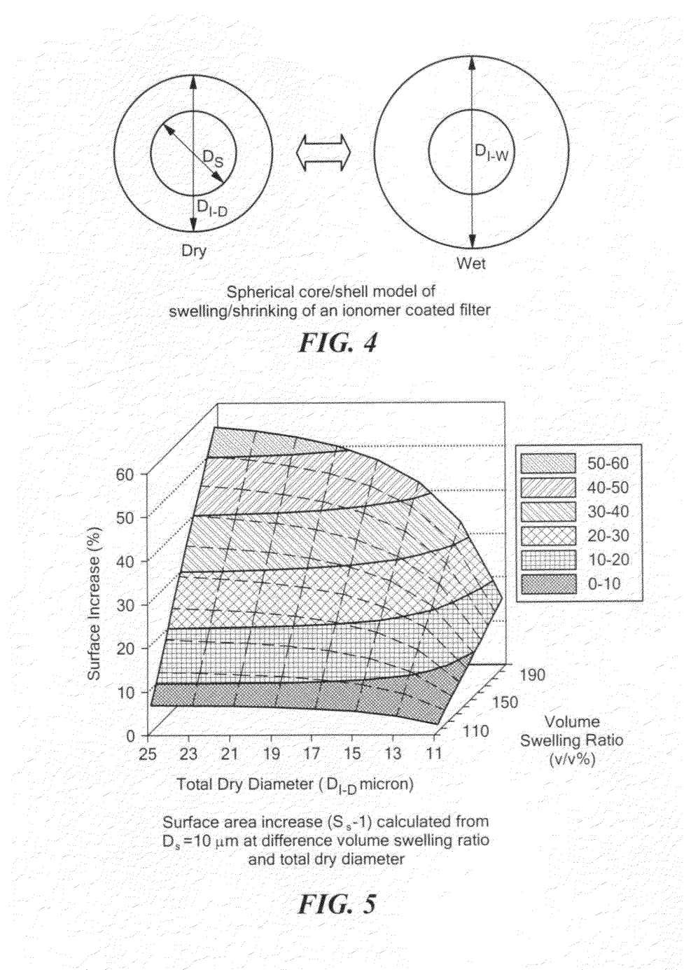

When the volume of the ionomer increases, the surface area also becomes larger. FIG. 4 illustrates, using a simple spherical core/shell model, how surface area increases when the ionomer is swelled by water. The swelling can be expressed as:

Thus:

(D_{I-D}³−D_{S}³)V_{swelling}%=D_{I-W}³−D_{S}³

Thus:

D_{I-W}=\sqrt{D_{I-D}³×V_{Swelling}%+D_{S}³×(100%−V_{swelling}%)}

The surface swelling ratio is:

$${S}_{S} = {( \frac{{D}_{I - W}}{{D}_{I - D}} )}^{2}$$

Where D_{S} is the diameter of the support, D_{I-D} is the diameter of the ionomer-coated sphere under a dry condition, D_{I-W} is the diameter of the ionomer-coated sphere under a wet condition and V_{swelling}% is the percentage of swelling under the wet condition.

Based on this simplified model, the percentage surface area increase can be calculated for different support diameter, total ionomer diameter and volume swelling ratio. As an example, the diameter of the support is assumed to be 10 μm. The surface area increases with different ionomer diameter, and volume swelling ratio can then be calculated (see FIG. 5). As expected, the thinner the ionomer layer, the less surface area increase; the higher the volume swelling, the greater the surface increase.

To combine the advantages of different pore design and various ionomer loadings, a filter media can be fabricated with multiple layers or multiple stages of the filter. Each filter can have different pore size and/or ionomer loading. Additionally, a composite filter media with a non-woven conventional filtration media layered on the filter can be prepared to combine the strength of different filter designs. The conventional filter media can contain ionomer fibers to enhance the cleaning capability.

The following examples are provided for illustrative purposes only and are in no way intended to limit the scope of the present invention:

### Example 1

### Laser Micromachining

Excimer laser micromachining is an effective method for providing pores 21 in support 13. The resulting support has uniform pore displacements with a narrow pore size distribution.

Based on the mask employed, the pore size is 30 μm and the wall thickness is 10 μm, which corresponds to a 50% overall opening. It is challenging to reduce 30 μm holes to a 5- to 10-μm diameter. Thus, a pattern with smaller holes is highly desirable.

Two masks were used for creating new patterns with smaller holes:

(1) Mask I: hole diameter 40 μm, wall thickness 8 μm

(2) Mask II: hole diameter 80 μm, wall thickness 28 μm

It should be noted that the hole diameter listed above is the value for the mask. When a photomask is used for laser micromachining, a demagnification lens is usually used. Normally, a 4× demagnification is employed. As a result, the first mask will create patterns with a hole diameter of 10 μm and wall thickness of 2 μm, and the second mask will create patterns with a hole diameter of 20 μm and wall thickness of 7 μm.

If 12 μm is the target for the second mask, then a demagnification ratio of 6× should be employed, which will result in a 13-μm hole and 4.6-μm wall. These numbers are usually just reference numbers as the actual pattern will strongly depend on the actual focus and material.

The first mask, with 4× demagnification, will result in a 2-μm wall, which can lead to mechanical issues. Since it can directly reach the target of a 10-μm hole, a 4× demagnification ratio is desirable compared to 6× in terms of fabrication cost. Therefore, a lasing trial was conducted.

KAPTON® polyimide films with nominal thickness of ⅓ mil (˜8.5 μm) and ⅔ mil (˜17 μm) were tested. The ⅓ mil KAPTON® polyimide film was 9 μm thick (slightly thicker than specified), and the ⅔ mil KAPTON® polyimide film was 15 μm thick (as expected). The entrance diameter was 11 μm for both samples. The exit diameter was 7 μm for the ⅓ mil film and 4.5 μm for the ⅔ mil film. Those values correspond to wall angles of 77.5° and 77.8°, respectively. It is also feasible to prepare microporous composite film substrates of 1 mil (2.5 μm). The preferred porosity for the above films is 40 to 50%, with a range of 40 to 60%. Besides using KAPTON® polyimide films, one could also use, for example, polysulfone, liquid crystal polymers and polybenzimidazole.

The results are significantly better with Mask II. KAPTON® polyimide films with both thicknesses can be successfully processed without major issues.

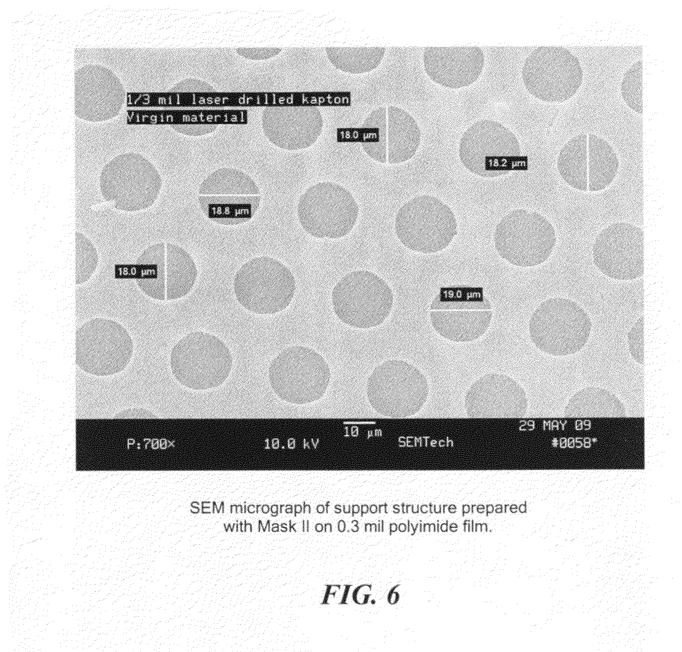

As shown in FIG. 6, the hole pattern is quite uniform. Only the exit holes are pictured. The hole diameter is larger than expected, presumably due to focusing errors.

### Example 2

### Micromolding

Testing was conducted to demonstrate that micromolding can be a viable alternative fabrication method to laser micromachining for preparing a microporous substrate with controlled straight pores.

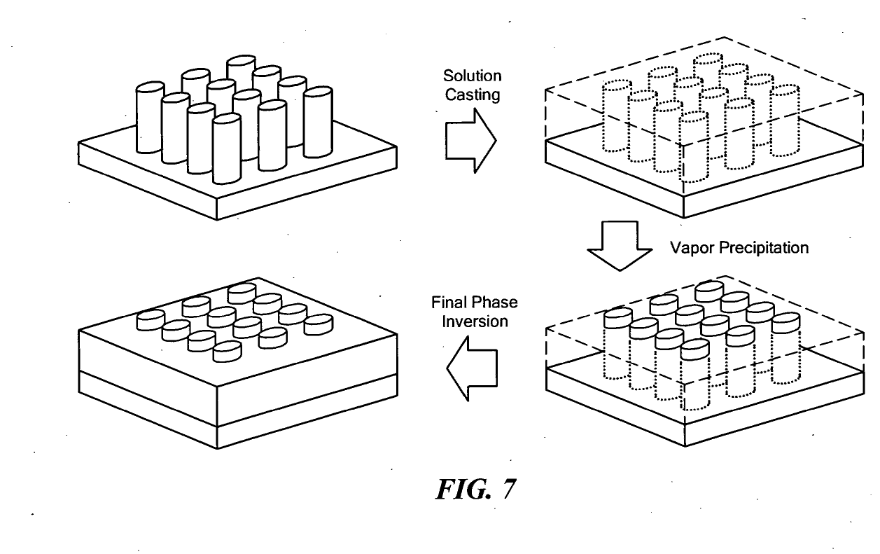

A schematic illustration of the micro-molding process is shown in FIG. 7. The entire fabrication process is based on the conventional phase-inversion membrane formation method, which has been commercially utilized to produce filtration membranes for decades. To summarize the process, a micromold is first prepared from silicone rubber (polydimethyl-siloxane, PDMS) by soft-lithography or silicon wafer by Deep Reactive Ion Etch (DRIE) technology. A polymer solution is then cast onto the mold. The whole assembly is then exposed to saturated water vapor, where the solvent is evaporated partially to expose the land area of the mold. To obtain the final product, the assembly is submerged in water and the polymer is solidified.

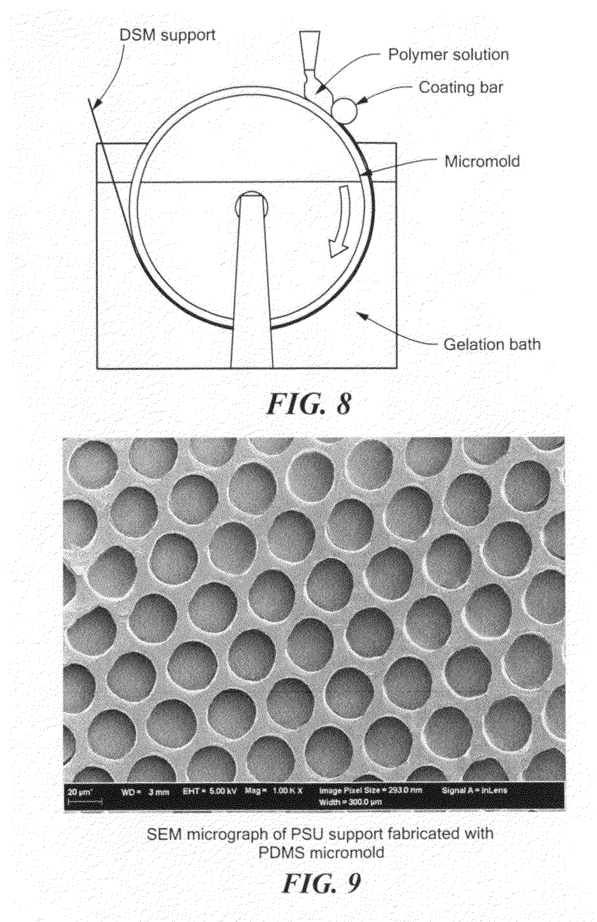

Based on a further development of this technology, it has been found that the coating process can be simplified by eliminating the vapor precipitation step while still maintaining the formation of open holes. As seen in FIG. 8, a simple coating wheel can be designed with the elimination of the precipitation step. The main issue is to maintain close contact between the coating bar and the micromolds. By using a semi-floating coating bar, the intermediate contact between the coating bar and the micromolds can be maintained.

The micromold was prepared based on the soft-lithography process discussed in the following: Kumar et al., Appl. Phys. Lett., 63:2002 (1993); Michel et al., IBM J. Res. & Dev., 45:697-719 (2001); Whitesides et al., Annu. Rev. Biomed. Eng., 3:335-73 (2001). The micromold is made of polysiloxane (silicone), which is flexible yet offers excellent durability. The micromolds are of great precision with minimal defect rate.

The dimensions of a polysulfone (PSU) support fabricated using the above-described PDMS micromolds are very close to the target structure. An SEM micrograph of a PSU support fabricated using a PDMS micromold is shown in FIG. 9. As can be seen from the micrograph, the definition of the holes is not as uniform as the sample prepared by laser micromachining. This arises because the PDMS is drastically softer than the silicon material. However, for purposes of the present invention, the definition should be more than sufficient. As can be seen from the cross-sectional micrograph, certain holes are partially covered by a thin skin. Since the skin is <0.5 μm in thickness, it can be easily removed by ultrasonification or oxygen plasma treatment.

### Example 3

### Ionomer Impregnation

To impregnate support 13 with ionomer, one may utilize an automated spraying technique. NAFION® PFSA suspension, with a solids content of 10-20%, can be obtained commercially (E.I. duPont, Wilmington, Del.). Ionomers comprising NAFION® PFSA materials with equivalent weights (EW) of 700 to 1100 were used. Alternatively, ionomers comprising hydrocarbon sulfonic acid materials, such as sulfonated polystyrene or polysulfone, may also be used.

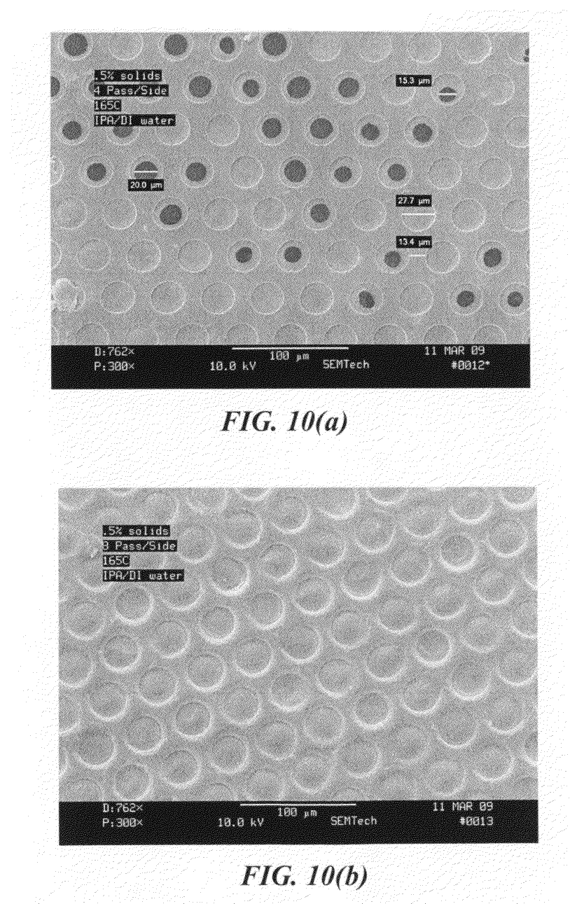

A spray solution comprising 2.5% NAFION® PFSA, 50% isopropyl alcohol (IPA), and the balance water can easily seal the pores of the support. However, according to the present invention, the pore diameter should be reduced, but not completely sealed off Thus, the solid content of the above-described solution was reduced by a factor of five to 0.5% NAFION® PFSA, 50% IPA, and the balance water. As can be seen in FIGS. 10(a) and 10(b), using this solution, a large percentage of the pores were sealed with only 4 passes/side spray. Increasing the spray to 8 passes led to completely sealed NAFION® PFSA ionomer-coated supports.

The main mechanism that causes pore seal-off is the capillary effect. The spray solution is absorbed into the holes when the solution is sprayed onto the support. During the dry-off process, a thin film is formed in the hole region. To alleviate the sealing problem, a solvent with low viscosity and low boiling point was employed, namely, acetone. The low viscosity of acetone helps prevent formation of a solid (non-gas porous) ionomer film during the evaporation of the solvent. The lower boiling point of acetone shortens the evaporation process, which also reduces solid ionomer film formation. The main issue with employing acetone as the solvent is that acetone leads to clogging of the sprayer nozzle. Further optimization was studied and the following changes were made: The spraying solution injection rate was increased from 5 mL/min to 6 mL/min, the spraying pen velocity was increased from 10 cm/sec to 15 cm/sec, and the distance between the spraying pen and the support was increased from about 10 cm to 20 cm. With these modifications, the spraying process could be carried out continuously without any interruptions.

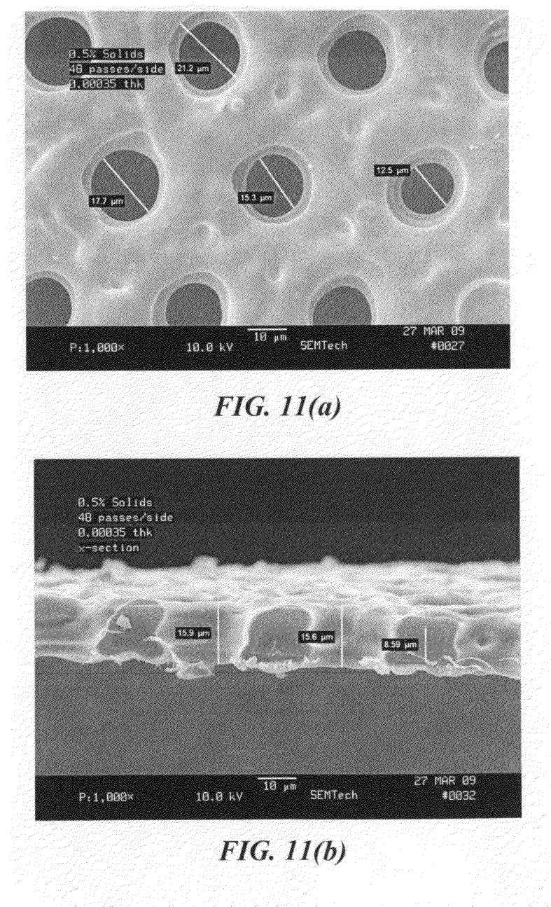

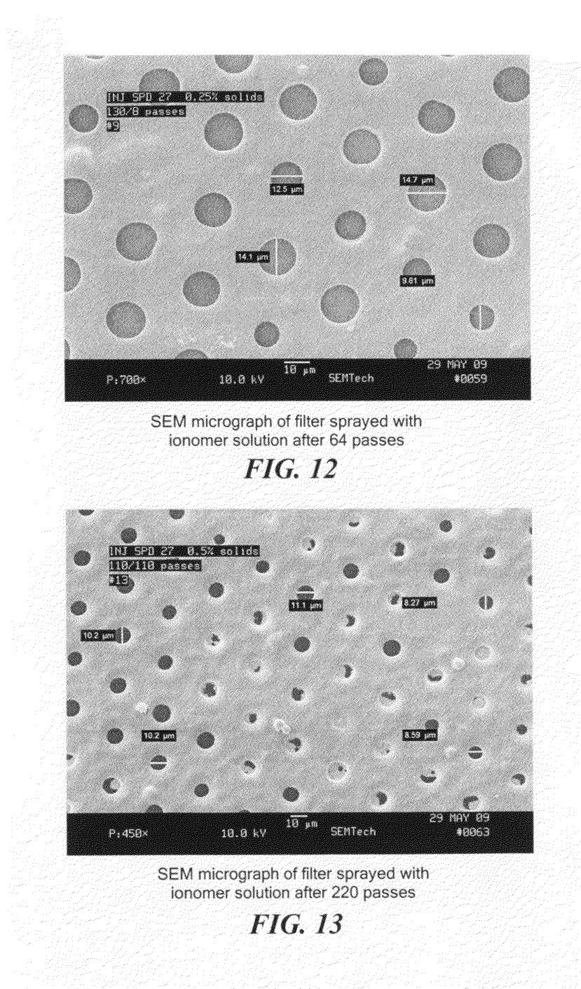

As seen in FIGS. 11(a) and 11(b), with more passes of spraying, the pore diameter decreases as expected. However, the overall standard deviation of the hole diameter is still very well controlled. As seen in FIG. 12, when the number of passes increases to 64, approximately 50% pores were sealed. However, sealed pores lead to higher pressure drop of the filter and, thus, is not desired.

It can be seen from these results that a pore opening of approximately 10 μm can be successfully obtained. Attempts to further reduce the pore diameter lead to film formation. To obtain smaller pores, the amount of solid in the spray solution can be reduced for 48-64 passes.

It is believed that the main issue is the surface tension of the spraying solution. Even with employment of acetone, which has very low viscosity, the solution is still preferentially wicked into the holes due to surface tension. Several modifications were studied to alleviate the problem.

Hot Plate Configuration: Previously, all of the spraying was conducted with a hot-air-gun configuration. The reason that an air gun was employed is that the support has a tendency to adhere to any hot surface. The air gun suspends the substrate without it being in contact with a solid surface. The main issue with the air gun is that the temperature is very difficult to control and the highest temperature achievable is only approximately 80-100° C.

To prevent holes from clogging, it is highly desirable to spray the sample at a higher temperature. A high temperature will lead to faster evaporation of the solvent, causing the holes to be more difficult to plug. An aluminum hot plate can easily reach a temperature exceeding 200° C. To eliminate the adhesion between the sample and the hot plate, a very thin coating of TEFLON® PTFE (polytetrafluoroethylene) spray was used. The TEFLON® PTFE coating effectively eliminated the adhesion issue.

Temperature of the Substrate: Temperatures ranging from 120° C. to 180° C. were studied with an interval of 20° C. It was found that the sample severely discolors at temperatures above 160° C. It is well known that the PFSA ionomer is stable at this temperature, so the ionomer itself should not change color. The discoloration can be a result of acid-catalyzed oxidization of the solvents. To prevent the discoloration, 140° C. was selected.

Solution Concentration: From the point of view of fabrication speed, it is desirable to use a high concentration of ionomer solution. However, a solution with a high polymer concentration will inevitably increase the chance that the holes will be blocked. Three solid concentrations were investigated: 0.5 wt %, 0.35 wt % and 0.25 wt %. As expected, the 0.5 wt % solution leads to early clogging of the holes. With 0.25 wt % solution, a considerable percentage of the holes were still clogged while the hole diameter was still too large.

Spray Nozzle: The final factor investigated was the spray nozzle. A new spray nozzle was installed to reduce the liquid particle size. It was found that the nozzle plays a critical role in hole plugging. Even with 0.5% solid content, a very uniform filter media can be prepared without severe blockage of the holes. As can be seen in FIG. 13, only very minor hole blockage was observed. Such a thin blocking film can be easily removed by applying air pressure across it. It can also be removed during normal air filtration process. One major issue with this filter is that the percentage of openings is relatively small. The majority of the surface is coated with NAFION® PFSA. As will be discussed below, filtration performance is very good even with this relatively small percentage of opening. Significant improvement on pressure can be expected by improvement of the percentage opening.

### Example 4

### Filtration Efficiency Test

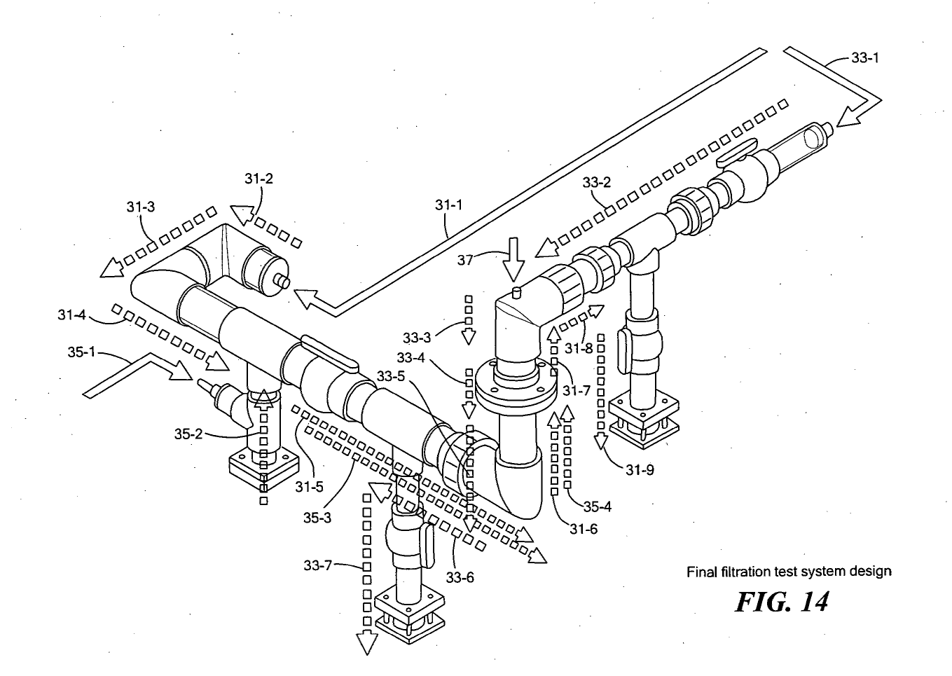

The final test system design is shown in FIG. 14. As seen in FIG. 14, there are two major air pathways: normal filtration (arrows 31-1 through 31-9) and back flushing (arrows 33-1 through 33-6). During the normal filtration stage, air is delivered by a mass flow controller into the system. A U-shaped air path is added to ensure the air velocity is uniform. Honeycomb cores are implemented inside the air path to disturb any vortex-developed air stream.

A separate air stream (arrows 35-1 through 35-4) is also delivered to a dust holder, which will be discussed later. The air carrying the dust flows past a ball valve and then go upwards through the filter fixture assembly. The filtered air is then directed through another ball valve reaching a commercial end-cap HEPA filter.

During the back flushing stage, the air is delivered to the other end of the system (arrow 33-7). It flows past the ball valve to reach the elbow, where a very light water spray is introduced to facilitate filter regeneration (arrow 37). The dust cake is then carried, back to the commercial end-cap HEPA filter on the left hand side.

The dust-delivery vessel is based on a NASA design. A small air stream is directed through a thin tube. The end of the thin tube is above a cavity where the test dust is held. During the filtration test stage, the dust is carried over by the air stream up towards the main air flow path. This design is recommended.

Particle concentration and filtration efficiency were characterized by a Lighthouse HANDHELD 3016 indoor air quality counter. The particle counter was connected to a ball valve that can direct the upstream/downstream flow to the counter manually. The counter was set at 17 sec per sample with a 3 sec hold period to avoid loose particles being counted during switching.

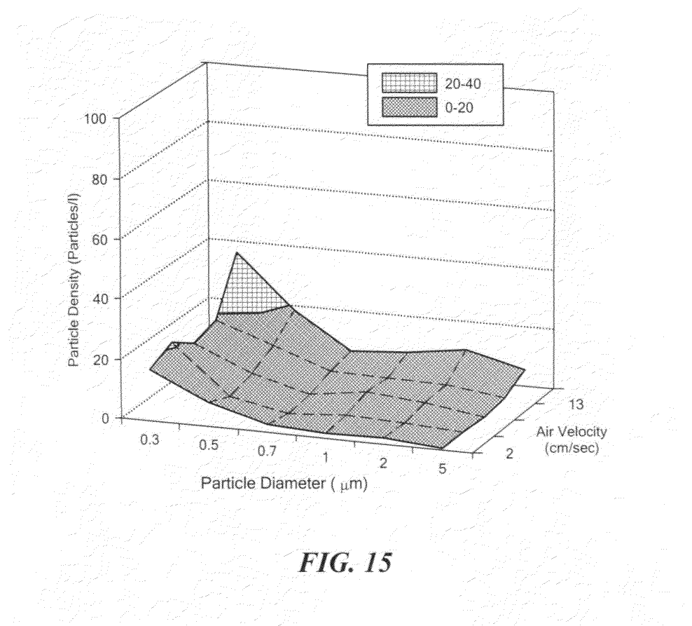

Before testing the particle filtration efficiency, the clean level of the system must be verified to ensure that the efficiency value is not compromised by the baseline particle density. For this experimentation, tanked N₂ was used as the source to simulate air flow. An ultra-fine filter with 10 nm filtration threshold was installed between the tank and the inlet of the mass flow controllers to further lower the particle count. As can be seen in FIG. 15, the particle density is very low for the clean system. There is no strong correlation between air velocity and particle density. By comparison, the measured room dust density is approximately 30,000 particles/1 in the lab, where the testing equipments are installed.

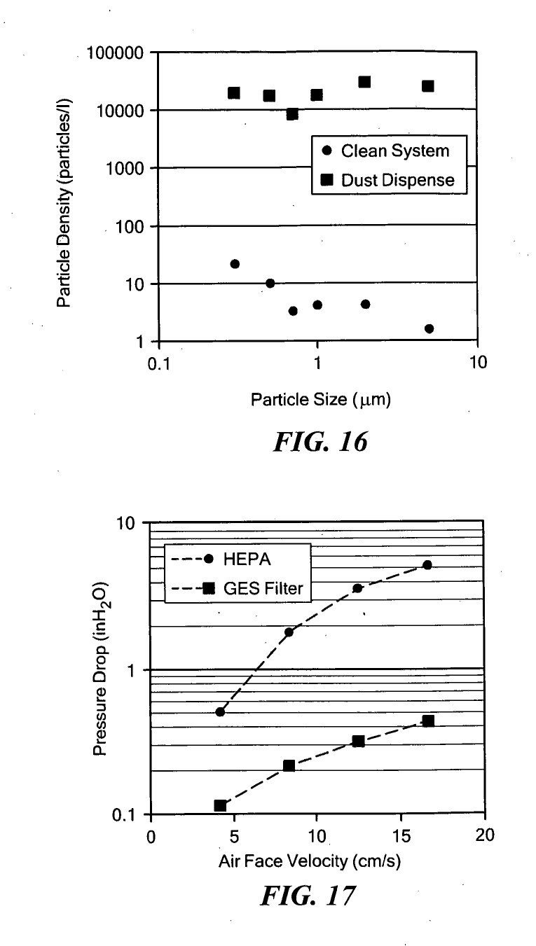

In a normal dust filtration test, precautions are taken to maintain the minimum dust density at approximately 10,000 for a given diameter range. As seen in FIG. 16, this translates to a maximum detectable efficiency of 99.9% or better for most diameter ranges. The only exception is the 0.3 μm range where 99.5% or better can be detected due to background particle density. As will be discussed in the following section, this performance does not pose any compromise to the efficiency data obtained. It is quite unexpected that the particle counter identified uniform particle counts across all channels, while sample dust is silicon microspheres that have a geometrical diameter of approximately 10 μm.

As seen in FIG. 17, even with the low percentage opening of the sample filter, the pressure drop of the composite microfilter of the present invention is still significantly lower than that for a reference HEPA filter. Both filters are clean without any dust contamination. The microfilter of the present invention exhibits approximately 1/10 the pressure drop of the HEPA filter, due to the thin thickness and straight pore structure without any tortuosity. It should be noted that the pressure drop value seems to be significantly higher than commercial HEPA filter specifications. The source of this difference originates from the configuration of the filter media. In commercial products, the filtration media is folded into the filter module to increase the actual filter area per geometric module area. Generally, a ratio of 10:1 can be achieved, i.e., a module with a geometric area of 100 cm² can actually contain approximately 1000 cm² filter media. In our filter test, the filter media is flattened between two titanium sheets and, thus, the results are based on the actual surface area of the filter media, not a filter module.

Based on this calculation, the HEPA filter generates a pressure drop of 0.5 in H₂O at an air face velocity of approximately 17 cm/sec. It is found that the pressure drop of the HEPA filter is worse with higher flow, a four-fold increase of the flow rate leads to a ten-fold increase of the pressure drop. It is possible that in this pressure range the fibers in the HEPA filter were compressed, leading to a higher pressure drop. The filter of the present invention behaves as predicted. To summarize, when comparing the results here to most commercial filter units, the pressure drop reported here should be reduced by 10×.

### Example 5

### Filtration Performance and Regeneration Protocol

The first set of filtration tests were conducted with 10 μm silica microspheres. Filter media prepared with 0.3 mil KAPTON® polyimide support was tested first. All the filtration efficiency tests were conducted at approximately 15 cm/sec air velocity to simplify the protocol.

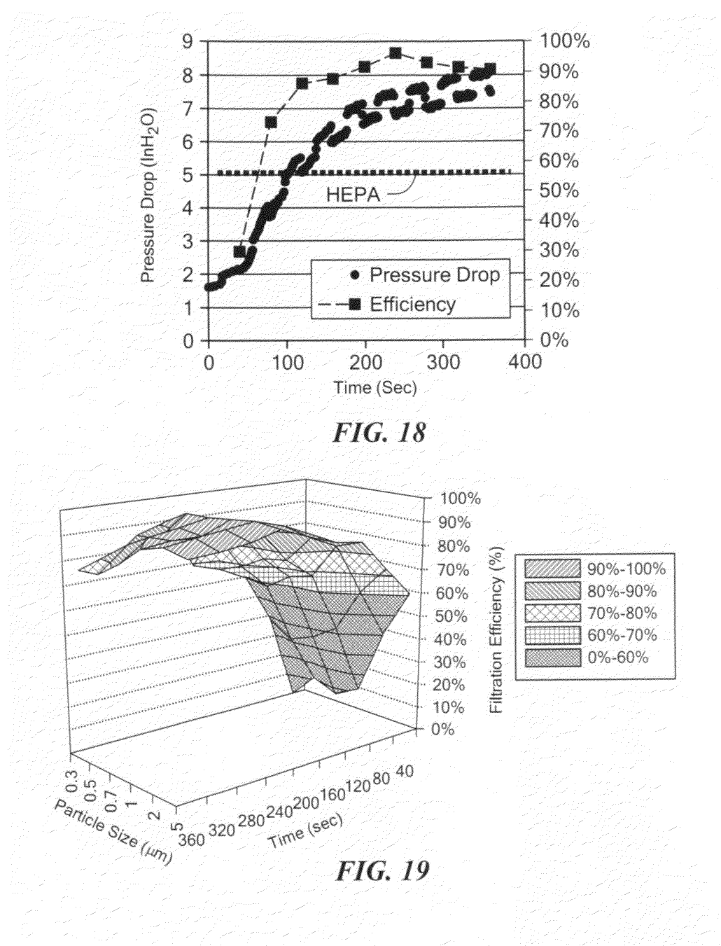

The filtration efficiency and corresponding pressure drop is shown in FIG. 18. As can be seen, there is a pressure shift every 20 seconds. This pressure shift is due to the particle counter which withdraws 0.1 cfm (˜2.8 L/min) air for particle measurement, where the total air flow is ca. 35 L/min. Thus, when the particle counter is measuring the particle density on the upstream side of the filter, it reduces the effective flow by 10%, which leads to approximately a 10% decrease of pressure drop. When the particle counter is measuring downstream, there is no significant impact.

As can be expected, the pressure drop increases with time, indicating the pores are gradually blocked and a dust cake is forming on the upstream side of the filter media. The initial filtration efficiency is also only 30% with a pressure drop of 2 in H₂O (corresponds to 0.2 in H₂O for a module). The pressure drop increases to a level similar to a clean HEPA filter within 100 sec, with efficiency improved to approximately 90%. After another 250 sec, the pressure drop increases to 60% higher than a clean HEPA, and the efficiency remains steady at 90%.

Detailed efficiency results with particle size distribution are shown in FIG. 19. At the beginning of the filtration test, the efficiency was very low with smaller particles. The efficiency for small particle filtration improves significantly faster than the efficiency for larger particles, which drastically improves the overall filtration efficiency. Clearly, even though the hole diameter of the composite microfilter of the present invention is significantly larger than 0.3 μm, a high filtration efficiency can be achieved for these small particles through partial hole blocking and dust cake formation.

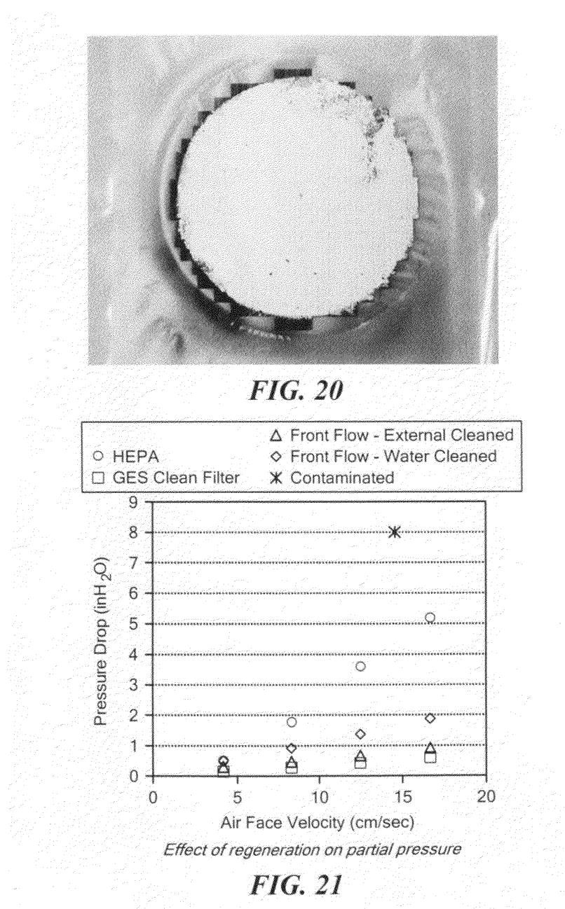

As seen in FIG. 20, at the end of the filtration test, the filter is completely covered by the microspheres. The thickness of the dust cake cannot be reliably determined. The area loading of the dust is approximately 15 mg/cm². For a small commercial unit with 25×7.5 cm² geometric area, the total dust loading would be 13.1 g before regeneration. It should be noted that the dust loading before regeneration depends strongly on dust cake density and the pre-determined pressure threshold for regeneration. As shown in FIG. 21, the increase rate of the pressure drop slows down at higher differential pressure. Thus, significantly more dust loading can be achieved if the higher differential pressure limit is allowed.

Two regeneration methods were investigated: external dust removal and in situ water spray. A simple air flow reversal was also evaluated.

During the air reversal test, the direction of the air flow is reversed, and the flow rate is controlled at the highest level achievable. In a real system design, the air blower capacity is usually carefully selected. Thus, during the reverse flow, the maximum achievable flow will be similar to the value of the forward flow, unless a second blower unit is used or the air blower was designed with a large conserved flow capability. Both cases will require significantly more weight/volume for the blower unit, which is not desirable. After the simple reverse flow, the forward flow was resumed with clean nitrogen and the differential pressure is measured. It is found that the differential pressure was reduced by approximately 50%, which is still higher than compared to a clean HEPA filter.

During the in situ water spray restoration process, a small amount of water is sprayed onto the filtration media, which leads to microscopic swelling of the coated NAFION® PFSA ionomer layer. The swelling of the NAFION® PFSA ionomer layer facilitates the dust removal. During the drying process, a reverse air flow is also applied to remove the dust cake. The volume of the NAFION® PFSA ionomer layer shrinks during the drying process and further facilitates the dust removal. As can be seen in FIG. 21, the pressure drop was significantly reduced after the restoration.

The best results were observed with external dust removal. The filter media was removed from the filter assembly. Several gentle bursts were applied with an air duster from the downstream side of the filter. The filter media was then reassembled and tested for pressure drop. As shown in FIG. 21, the pressure drop was almost completely restored to the original value. Thus, a localized reverse flow is the best method to regenerate the filter. Such process does not require an extra large blower unit and can be achieved in situ without the filter removal through good engineering.

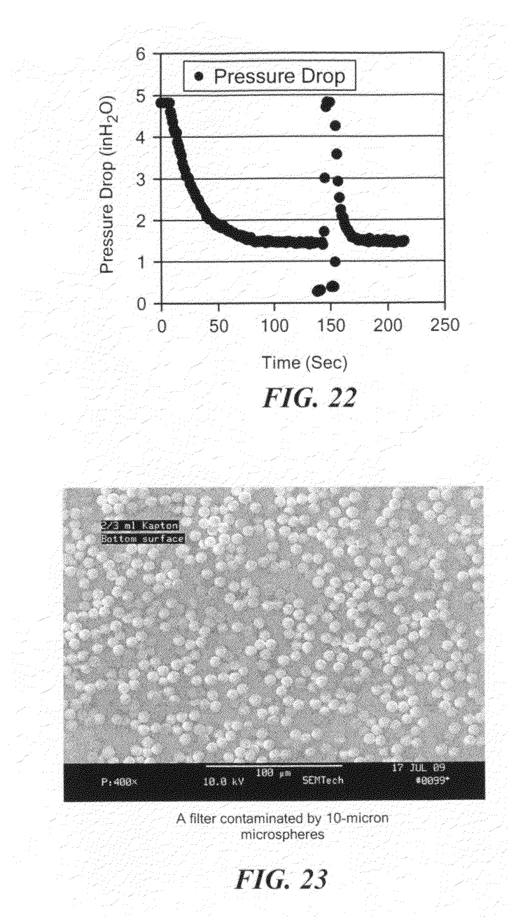

With the water spray method, the dry out time was also studied. As seen in FIG. 22, when water is applied to the filtration media surface, the pressure drop increases due to the formation of a thin film of water and swelling of the ionomer. The pressure is gradually reduced with dry nitrogen flowing through. As expected, the time period for pressure restoration depends on the amount of water applied. For the first period, the water is sprayed for 10 sec, which corresponds to a restoration time of approximately 100 sec. During the second period, the water was only applied for 5 sec, and the pressure was restored within 30 sec. The actual amount of water that reaches the filter media is difficult to estimate since a significant amount of water is sprayed onto the fixture wall, due to the limitation of the system design. Assuming all the water is on the filtration media, the amount of water is calculated to be 10 mg/cm² for a 5 sec spray.

The contaminated filter shown in FIG. 23 shows the dust particles concentrated near the holes. Reverse air flow in combination with water spray can successfully remove the particles.

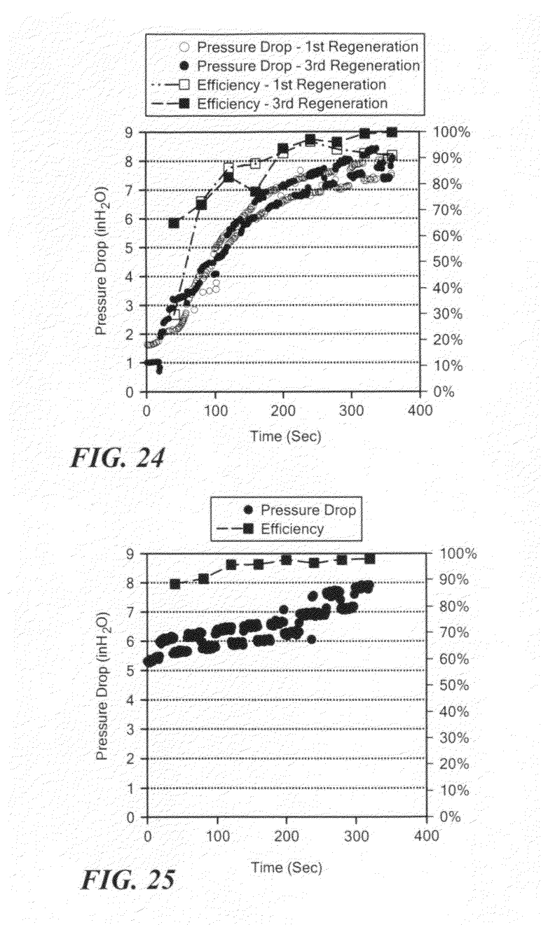

The reproducibility of filter regeneration was also evaluated in FIG. 24. During three regeneration cycles, the filter behavior is highly reproducible. The starting filtration efficiency increases significantly presumably due to some pores that are still partially blocked by the dust particles. The overall efficiency trends are very similar with slightly higher efficiency (99% vs. 90%) in the high pressure drop region. Overall, there is no significant degradation of performance after three regeneration cycles.

Certain difficulties were encountered in steadily dispensing the dust. (The initial dust dispensing was not uniform.) After some adjustments of flow rate on the dust dispenser, the particle density became stable. At this stage, the filtration media was already partially blocked, as seen in FIG. 25. The overall efficiency of the filter is higher than expected. During the second half of the test, the overall efficiency remained steady over 97%.

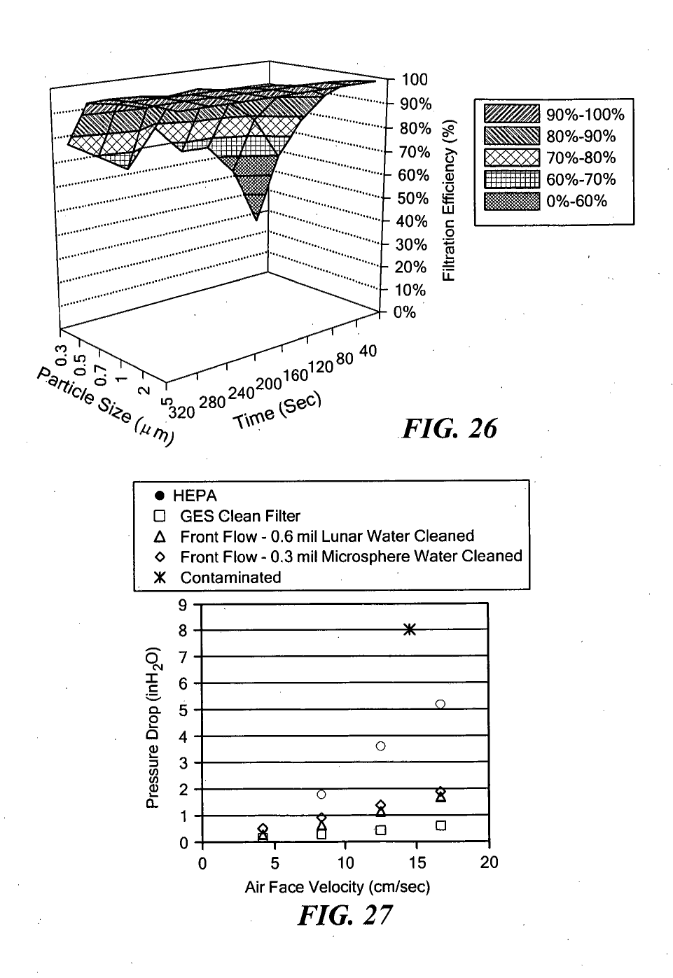

To further examine the filtration efficiency, the efficiency was broken down with different particle sizes, as shown in FIG. 26. Based on these numbers, the efficiency of lunar dust removal is actually higher than that for the microspheres. It should be noted that the Lighthouse particle counter may not the best instrument to characterize the particle size distribution of the lunar dust simulant. The particle counter is designed for spherical particles, while the lunar dust simulant and actual lunar dust, contained mainly highly irregular particles. Overall, the filtration efficiency was very good.

The filtration media contaminated by lunar dust was regenerated in a similar fashion to microsphere-contaminated filter media. The pressure was successfully restored with the water cleaning method. As can be seen in FIG. 27, the lunar dust simulant can be removed similarly to the microspheres, and the performance of the filter media can be successfully restored.

Another filtration media was also comparatively examined in this program: anodic alumina disc. The anodic alumina is prepared by electrochemically oxidizing an aluminum surface with proper voltages and acidic media. With proper fabrication parameters, a self-assembled porous structure can be formed. By tuning the type of acid, concentration of the acid and voltage, the pore diameter can be modified. The other unique feature of such a structure is that it contains straight, through pores with low tortuosity due to the self-assembling behavior. Commercial products, with different pore sizes down to 0.1 μm (100 nm), can be purchased from Whatman Plc. as water filters.

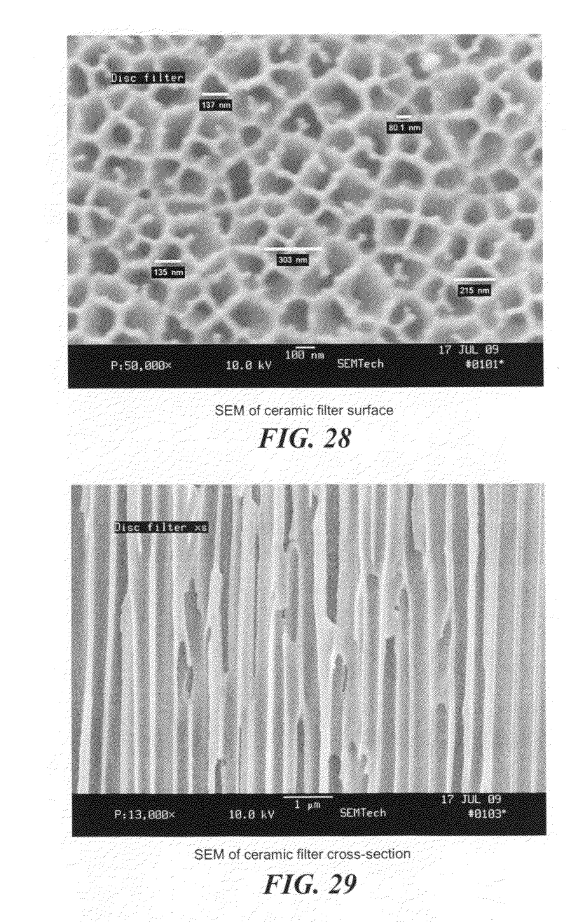

SEM micrographs of the alumina disc filter are shown in FIGS. 28 and 29. The pore distribution is quite uniform and tortuosity of the pores is low.

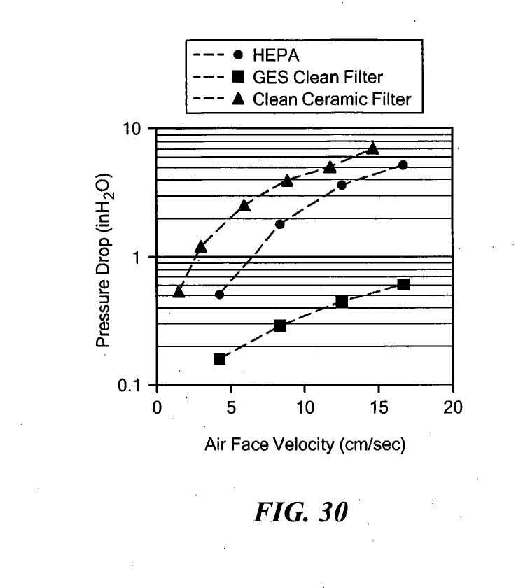

Due to the small pore diameter, the pressure drop of the alumina disc filter (also referred as ceramic filter) is moderately higher than that for the HEPA filter and significantly higher than that for the microfilter of the present invention, as is seen in FIG. 30. At high air velocity, the ceramic filter shows 30% higher pressure drop than for a clean HEPA filter and over an order of magnitude higher pressure drop than for the microfilter of the present invention.

The embodiments of the present invention described above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A filter well-suited for removing particulates from a gas, the filter comprising:
(a) a support, the support comprising a plurality of straight pores extending from one surface of the support to an opposite surface of the support; and
(b) an ionomer coating applied to the support, the ionomer coating partially filling but not completely sealing at least some of the straight pores.

2. The filter as claimed in claim 1 wherein the support is a non-ionomer polymer film.

3. The filter as claimed in claim 2 wherein the non-ionomer polymer film is made of a material selected from the group consisting of perfluorinated polymers, polyvinylidene fluoride, poly(tetrafluoroethylene), polybenzimidazole, polyphenylenesulfide, polysulfone, polyethersulfone, polyesters, polyparaphenylene, polyquinoxaline, polyarylketone, polybenzazole, polyaramid, poly(etherether-ketone), liquid crystal polymers, polyimide, and polyetherimide.

4. The filter as claimed in claim 3 wherein the non-ionomer polymer film is made of a material selected from the group consisting of polyimide, a liquid crystal polymer, and polybenzimidazole.

5. The filter as claimed in claim 4 wherein the non-ionomer polymer film is made of polyimide.

6. The filter as claimed in claim 4 wherein the non-ionomer polymer film is made of a liquid crystal polymer.

7. The filter as claimed in claim 4 wherein the non-ionomer polymer film is made of polybenzimidazole.

8. The filter as claimed in claim 1 wherein the straight pores have a pore size of about 10 to 80 μm.

9. The filter as claimed in claim 1 wherein the straight pores have a pore size of about 10 to 30 μm.

10. The filter as claimed in claim 1 wherein the support has a thickness of about 9 to 25 μm.

11. The filter as claimed in claim 1 wherein the support has a thickness of about 9 to 15 μm.

12. The filter as claimed in claim 1 wherein the support has a porosity of about 40 to 60%.

13. The filter as claimed in claim 1 wherein the support has a porosity of about 40 to 50%.

14. The filter as claimed in claim 1 wherein the ionomer coating comprises an ionomer having an equivalent weight of about 700 to 1100.

15. The filter as claimed in claim 1 wherein the ionomer coating comprises a perfluorinated sulfonic acid.

16. The filter as claimed in claim 1 wherein the ionomer coating comprises a sulfonated hydrocarbon.

17. The filter as claimed in claim 1 wherein the filter has a dust removal efficiency of about 90 to 99%.

18. The filter as claimed in claim 1 wherein the filter has a dust removal efficiency of about 95 to 99%.

19. A filter assembly, the filter assembly comprising a plurality of stacked filters, at least one of said stacked filters comprising a filter as claimed in claim 1.

20. A filter assembly, the filter assembly comprising a first filter and a second filter, said second filter being stacked on said first filter, said first filter comprising a non-woven porous fabric, said second filter comprising a filter as claimed in claim 1.

21. The filter assembly as claimed in claim 20 wherein said first filter comprises ionomer fibers.

22. A filter assembly, the filter assembly comprising a plurality of stacked filters, each of said stacked filters comprising a filter as claimed in claim 1.

23. The filter assembly as claimed in claim 22 wherein each of said stacked filters has a different pore size and/or ionomer loading.

24. A method of filtering particulates from a gas, the method comprising the steps of:
(a) providing a filter, the filter comprising
(i) a support, the support comprising a plurality of straight pores extending from one surface of the support to an opposite surface of the support;
(ii) an ionomer coating applied to the support, the ionomer coating partially filling but not completely sealing at least some of the straight pores, and
(b) passing the gas through the pores of the filter.

25. The method as claimed in claim 24 wherein the support is a non-ionomer polymer film made of a material selected from the group consisting of polyimide, a liquid crystal polymer, and polybenzimidazole, wherein the straight pores of the support have a pore size of 10 to 80 μm., and wherein the ionomer coating comprises a perfluorinated sulfonic acid having an equivalent weight of about 700 to 1100.

26. A method of preparing a gas particulate filter, said method comprising the steps of:
(a) forming a support having a plurality of straight pores; and
(b) applying an ionomer to the support so as to partially fill, but not completely seal, at least some of the straight pores.

27. The method as claimed in claim 26 wherein said support forming step comprises providing a support and using a laser to micromachine straight pores in the support.

28. The method as claimed in claim 27 wherein said laser is an excimer laser.

29. The method as claimed in claim 26 wherein the support having a plurality of straight pores is formed by micromolding.
